(19) United States
(12) Patent Application Publication
(10) Pub. No.: US 2015/0308585 A1
(43) Pub. Date: Oct. 29, 2015

(54) Valve, Valve Device and Method for Assembling a Valve Device

(71) Applicant: KNORR-BREMSE Systeme fuer Nutzfahrzeuge GmbH, Muenchen (DE)

(72) Inventors: Laszlo KONCZ, Kecskemet (HU); Gabor FARKAS, Kecskemet (HU); Lajos PAPP, Kiskunfelegyhaza (HU); Attila MAJLATH, Kecskemet (HU)

(21) Appl. No.: 14/796,114

(22) Filed: Jul. 10, 2015

Related U.S. Application Data
(63) Continuation of application No. PCT/EP2014/050303, filed on Jan. 9, 2014.

(30) Foreign Application Priority Data
Jan. 11, 2013 (DE) 10 2013 100 247.1

(51) Int. Cl. F16K 31/60

(52) U.S. Cl. CPC F16K 31/602

(57) ABSTRACT

A valve, in particular a pneumatic suspension valve for a vehicle, is provided. The valve includes a valve body with a driver. The driver has a receiving section for receiving an actuating lever which can be fixed on the driver. Said receiving section is design to receive, without retrofitting the receiving section, an actuating lever having a first cross-sectional profile to receive an actuating lever having a second cross-sectional profile which is different from the first cross-sectional profile.

### CROSS REFERENCE TO RELATED APPLICATIONS

This application is a continuation of PCT International Application No. PCT/EP2014/050303, filed Jan. 9, 2014, which claims priority under 35 U.S.C. §119 from German Patent Application No. 10 2013 100 247.1, filed Jan. 11, 2013, the entire disclosures of which are herein expressly incorporated by reference.

### BACKGROUND AND SUMMARY OF THE INVENTION

The present invention relates to a valve, in particular a pneumatic suspension valve for a vehicle, to a valve device and to a method for assembling a valve device.

It is commonly the case that a valve can be actuated by way of an actuation lever. An actuation lever may be mounted on a driver of the valve. In this case, the driver serves for transmitting movement between the actuation lever and valve. Often, however, a valve of this type is intended for use in a variety of environments, which necessitates expensive, specific conversion for the respective usage scenario.

It is the object of the present invention to provide an improved valve, in particular a pneumatic suspension valve for a vehicle, an improved valve device and an improved method for assembling a valve device.

This and other objects are achieved by a valve, a valve device having the valve and a method for assembling a valve device, in accordance with embodiments of the invention.

A valve, in particular a pneumatic suspension valve for a vehicle, has a valve body with a driver. The driver has a receiving section for receiving an actuation lever which can be attached to the driver. The receiving section is designed so as to receive an actuation lever with a first cross-sectional profile or an actuation lever with a second cross-sectional profile, which differs from the first cross-sectional profile, without the need to retrofit the receiving section.

The vehicle may be a motor vehicle, in particular a road-going motor vehicle such as a passenger motor vehicle, a heavy goods vehicle or some other utility vehicle. The valve may be used, in particular, in conjunction with a pneumatic suspension system of a vehicle. The valve body may have fluid ducts and a shut-off element which is mechanically connected to the driver. The driver may serve for transmitting a movement or a force between the actuation lever and the valve body, in particular the shut-off element of the valve body. The receiving section may be formed in the driver. The receiving section may be designed to receive the actuation lever, wherein the actuation lever is movable along a main axis of extent of the actuation lever.

A valve device has the following features:

a version of the abovementioned valve; and

an actuation lever having a first cross-sectional profile or a second cross-sectional profile, wherein the actuation lever, in order to be attached to the driver of the valve, can be or is received in the receiving section of the driver.

A version of the abovementioned valve may advantageously be used as part of the valve device, in particular for advantageous attachment of an actuation lever to the valve.

A method for assembling a valve device includes the following acts:

providing a valve body having a driver and an actuation lever which can be attached to the driver and which has a first cross-sectional profile or a second cross-sectional profile; and

arranging the actuation lever in a receiving section which is arranged on the driver and which is designed so as to receive an actuation lever with a first cross-sectional profile or an actuation lever with a second cross-sectional profile, which differs from the first cross-sectional profile, without the need to retrofit the receiving section.

By carrying out the method, a version of the abovementioned valve device can be assembled in an advantageous manner.

In embodiments of the present invention, a driver of a valve may be designed to receive actuation levers with two different cross-sectional profiles, for example either a cylindrical or a flat lever or arm for the actuation of the valve. The receiving opening or the receiving section of the driver is realized by way of a combination of the two cross-sectional profiles or shapes, for example cylindrical and tetragonal.

It is advantageously the case, in embodiments of the present invention, that a fixing facility is realized for two different lever types or lever designs, for example cylindrical and flat, without the addition of new elements. A fixing arrangement is advantageously realized which can receive two different cross-sectional profiles of levers, for example both a cylindrical lever and a flat lever, without the need for any modification of the driver. Thus, a combined fixing device for a flat lever and for a circular, bar-shaped lever is realized in particular in a simple, economical and space-saving manner. It is thus possible for different actuation levers to be attached to a valve owing to the receiving section according to embodiments of the present invention. Furthermore, the lever may be received in displaceable fashion in the driver such that a length of the lever in the direction of an actuation device can be adjusted. Such an adjustable length, for example of a flat lever, may make it possible for a lever of uniform length to be utilized for different installation conditions or requirements.

In one embodiment of the abovementioned valve, it may be provided that the receiving section has a circular profile section for receiving an actuation lever with a circular cross-sectional profile and has a tetragonal profile section for receiving an actuation lever with a tetragonal cross-sectional profile. Such an embodiment offers the advantage that two customary and widely used cross-sectional profiles of actuation levers can be received in a receiving section formed in this way.

In this case, the circular profile section and the tetragonal profile section of the receiving section may extend through the driver as a common passage opening along a receiving axis of the actuation lever in the receiving section. In this case, the circular profile section and the tetragonal profile section of the receiving section may have a common central axis of longitudinal extent through the driver. Such an embodiment offers the advantage that a space-saving receptacle for an actuation lever with a, for example, circular cross-sectional profile or tetragonal cross-sectional profile is provided.

In particular, the receiving section may be designed to engage in U-shape fashion around narrow sides of a tetragonal cross-sectional profile of an actuation lever with a tetragonal cross-sectional profile. In this case, the receiving section can be placed in contact with the narrow sides of the tetragonal cross-sectional profile and with subsections, adjoining the narrow sides, of long sides of the tetragonal cross-sectional profile. The receiving section may also be designed such that, to fasten an actuation lever with a tetragonal cross-sectional profile, said receiving section engages with firm clamping action around the narrow sides of the actuation lever. A narrow side may be understood to mean a side of the actuation lever which has a smaller width than at least one other side of the actuation lever. In this case, the receiving section may be designed to make mechanical contact with subsections, adjoining the narrow sides, of long sides of the actuation lever with a tetragonal cross-sectional profile. Instead of the actuation lever being fixed only at its main surfaces, the actuation lever is engaged around and/or clamped at the narrow sides, such that the actuation lever with the tetragonal cross-sectional profile can be easily inserted into the receiving section and, if necessary, easily displaced in the receiving section relative to the driver.

Furthermore, the receiving section may be designed such that it can be placed in contact with two circumferential subsections of a circular cross-sectional profile of an actuation lever with a circular cross-sectional profile. Here, the receiving section is designed such that it can be placed in abutment against the circular cross-sectional profile of the actuation lever with circular cross-sectional profile over a part of the circumference. In particular, the receiving section may be designed such that it can be placed in contact with a first circumferential subsection of less than 180 degrees and with a second circumferential subsection of less than 180 degrees of the circular cross-sectional profile of the actuation lever. Such an embodiment offers the advantage that the actuation lever with the circular cross-sectional profile can be easily inserted into the receiving section and, if necessary, easily displaced in the receiving section relative to the driver.

Also, a fastening device may be provided which can be or is arranged on the driver and which serves for the fastening of the actuation lever in the receiving section of the driver. The fastening device may have a threaded bore or the like which is formed in the driver adjacent to the receiving section and in which a screw or the like can be or is received. Thus, the fastening device may have a threaded bore and, if appropriate, a screw. By means of the fastening device, a receiving cross-sectional area of the receiving section can be varied in order to fasten the actuation lever in the receiving section. Such an embodiment offers the advantage that the actuation lever can be securely held and fastened in the receiving section.

In this case, the fastening device may have an axis of longitudinal extent which extends substantially transversely with respect to a receiving axis of the actuation lever in the receiving section. An extent oriented substantially transversely with respect to a receiving axis of the actuation lever in the receiving section may be understood to mean an orientation whereby the orientation of the axis of longitudinal extent is oriented transversely with respect to the receiving axis of the actuation lever within a tolerance range of, for example, 20 degrees of deviation. Such an embodiment offers the advantage that a receiving cross-sectional area of the receiving section can be varied in a simple manner in order to fasten the actuation lever in the receiving section. In this case, a high clamping force can be exerted on the actuation lever.

In one embodiment of the abovementioned method, an act of fastening the actuation lever in the receiving section of the driver by use of a fastening device which can be or is arranged on the driver may be provided. In this case, by way of the fastening device, a receiving cross-sectional area of the receiving section may be varied in order to fasten the actuation lever in the receiving section. Such an embodiment offers the advantage that the actuation lever can be securely held and fastened in the receiving section.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is an illustration of a first valve device;

FIG. 2 is an illustration of a second valve device;

FIG. 3 is an illustration of a valve device according to an exemplary embodiment of the present invention in a first view with a first actuation lever;

FIG. 4 is an illustration of the valve device according to the exemplary embodiment of the present invention in a second view;

FIG. 5 is an illustration of the valve device according to the exemplary embodiment of the present invention in a first view with a second actuation lever;

FIG. 6 is an illustration of the valve device according to the exemplary embodiment of the present invention in a different view; and

FIG. 7 is a flow diagram of a method according to an exemplary embodiment of the present invention.

### DETAILED DESCRIPTION OF THE DRAWINGS

In the following description of the preferred exemplary embodiments of the present invention, the same or similar reference signs will be used to denote elements of similar action illustrated in the various drawings, wherein a repeated description of such elements will be omitted.

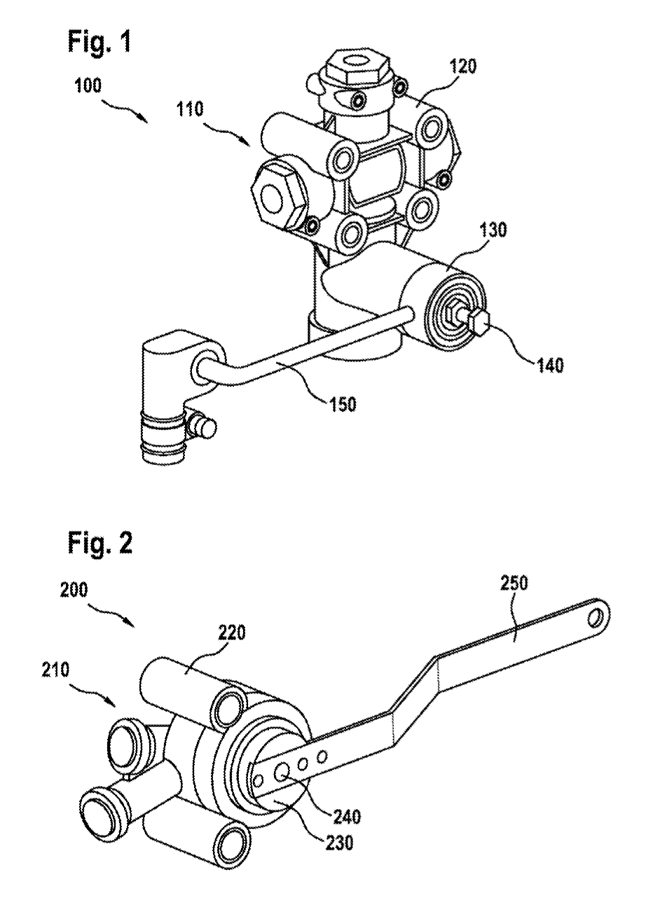

FIG. 1 is a perspective illustration of a valve device 100. The valve device 100 has a valve 110 with a valve body 120 and with a driver 130. Furthermore, the valve device 100 has a fastening device 140 and an actuation lever 150. The actuation lever 150 is attached to the driver 130 of the valve 110 by way of the fastening device 140. The actuation lever 150 has a circular cross-sectional profile. The driver 130 and the fastening device 140 are designed specifically for attachment of the actuation lever 150 with the circular cross-sectional profile as shown in FIG. 1.

FIG. 2 is a perspective illustration of a valve device 200. The valve device 200 has a valve 210 with a valve body 220 and with a driver 230. Furthermore, the valve device 200 has a fastening device 240 and an actuation lever 250. The actuation lever 250 is attached to the driver 230 of the valve 210 by way of the fastening device 240. The actuation lever 250 has a tetragonal cross-sectional profile. The driver 230 and the fastening device 240 are designed specifically for the attachment of the actuation lever 250 with the tetragonal cross-sectional profile as shown in FIG. 2.

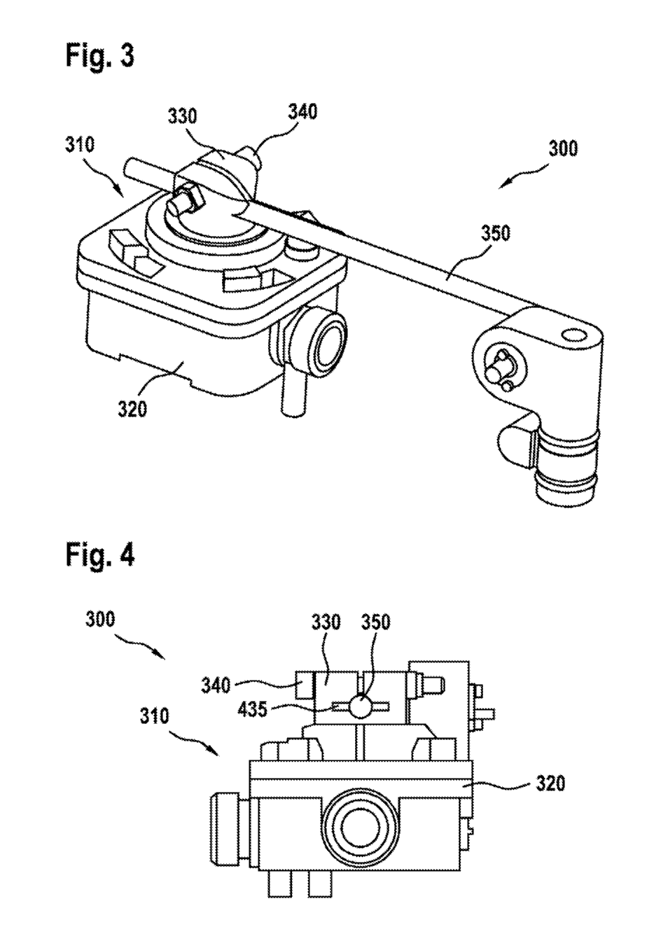

FIG. 3 is a perspective illustration of a valve device 300 according to an exemplary embodiment of the present invention. The valve device 300 has a valve 310, a valve body 320, a driver 330, a fastening device 340 and an actuation lever 350. The valve 310 has the valve body 320, the driver 330 and the fastening device 340. The valve may be a pneumatic suspension valve for a motor vehicle. The driver 330 is part of the valve body 320 or is attached to the valve body 320.

The actuation lever 350 has a circular cross-sectional profile. Thus, the actuation lever 350 is cylindrical or in the form of a cylindrical bar. The actuation lever 350 is attached to the driver 330 of the valve 310. In this case, the actuation lever 350 is received in a receiving section of the driver 330, said receiving section not being explicitly shown in FIG. 3 but being illustrated in FIG. 4. The actuation lever 350 is fastened in the receiving section of the driver 330 of the valve 310 by use of the fastening device 340. The actuation lever 350 has an actuation end and an insertion end. In FIG. 3, by way of example, the actuation lever 350 is in an arrangement having been pushed through the receiving section, wherein a subsection of the actuation lever 350 protrudes at its insertion end beyond the receiving section or the driver 330.

The receiving section, which is not explicitly shown in FIG. 3 but is illustrated in FIG. 4 and described with reference to FIG. 4, of the driver 330 extends in the manner of a passage opening along a receiving axis through the driver 330 of the valve 310. The fastening device 340 has, for example, a bore through the driver 330, a screw and a nut. In this case, the bore extends transversely with respect to the receiving axis of the receiving section in the driver 330. The screw of the fastening device 340 is arranged in the bore and extends through said bore. The nut is screwed onto the screw. The fastening device 340 is designed for the detachable fastening of the actuation lever 350 in the receiving section of the driver 330.

FIG. 4 is a perspective illustration of the valve device 300 from FIG. 3 from a different viewing angle. The figure shows the valve device 300, the valve 310, the valve body 320, the driver 330, the fastening device 340, the actuation lever 350 and a receiving section 435. The view in FIG. 4 shows the valve device 300 from FIG. 3 in a plan view of the insertion end, which protrudes beyond the receiving section 435 or the driver 330, of the actuation lever 350. FIG. 4 thus also shows the circular cross-sectional profile of the actuation lever 350.

The receiving section 435 is of similar form to a keyhole for a double-bit key. Thus, the receiving section 435 has a circular profile section for receiving the actuation lever 350 with the circular cross-sectional profile and a tetragonal profile section for receiving an actuation lever with a tetragonal cross-sectional profile. In this case, the circular profile section and the tetragonal profile section of the receiving section 435 have a common central point of their cross-sectional areas. The actuation lever 350 with the circular cross-sectional profile is received in the circular profile section of the receiving section 435. Thus, the tetragonal profile section of the receiving section 435 is at least partially unfilled.

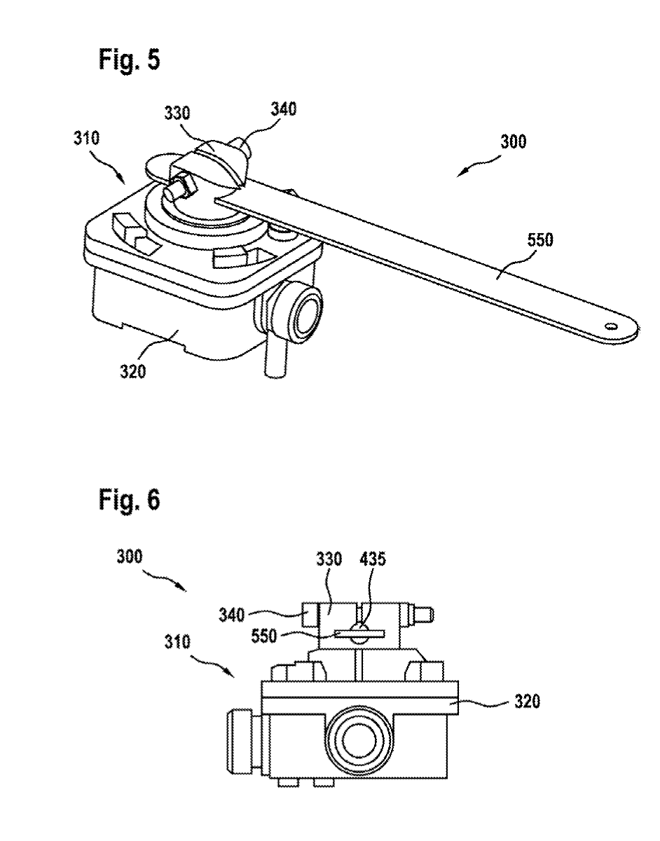

FIG. 5 is a perspective illustration of the valve device 300 from FIG. 3 or FIG. 4, wherein the valve device 300 has an actuation lever 550 with a tetragonal cross-sectional profile instead of the actuation lever with the circular cross-sectional profile. The tetragonal cross-sectional profile of the actuation lever 550 has in this case a length which is at least two times, for example at least four times, greater than a width thereof. Aside from the actuation lever 550, the valve device 300 shown in FIG. 5 corresponds to the valve device from FIG. 3 and FIG. 4.

FIG. 6 is a perspective illustration of the valve device 300 from FIG. 5 from a different viewing angle. The figure shows the valve device 300, the valve 310, the valve body 320, the driver 330, the fastening device 340, the receiving section 435 and the actuation lever 550. The view in FIG. 4 shows the valve device 300 from FIG. 5 in a plan view of the insertion end, protruding beyond the receiving section 435 or the driver 330, of the actuation lever 550. FIG. 6 thus also shows the tetragonal cross-sectional profile of the actuation lever 550. The valve 310, and thus also the receiving section 435, is the valve shown in and described with regard to FIG. 3 and FIG. 4. The actuation lever 550 with the tetragonal cross-sectional profile is received in the tetragonal profile section of the receiving section 435. Thus, the circular profile section of the receiving section 435 is partially unfilled.

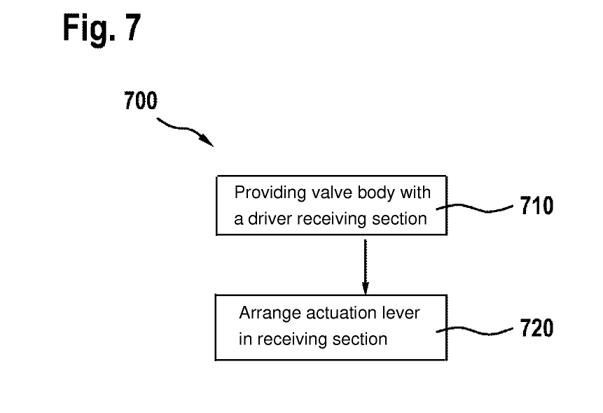

FIG. 7 is a flow diagram of a method 700 according to an exemplary embodiment of the present invention. The method 700 serves for the assembly of a valve device. The valve device that can be assembled by means of the method 700 is, for example, the valve device from FIGS. 3 to 6. The method 700 comprises an act 710 of providing a valve body having a driver and an actuation lever which can be attached to the driver and which has a first cross-sectional profile or a second cross-sectional profile. The method 700 also has an act 720 of arranging the actuation lever in a receiving section which is arranged on the driver. The receiving section is designed so as to receive an actuation lever with a first cross-sectional profile or an actuation lever with a second cross-sectional profile, which differs from the first cross-sectional profile, without the need to retrofit the receiving section.

In particular, in the act 720 of arranging, the actuation lever may be pushed into the receiving section of the driver, wherein an insertion end of the actuation lever is entirely or partially pushed through the receiving section or pushed through the receiving section and beyond the receiving section. This makes it possible to perform a length adjustment or length adaptation of the actuation lever. Furthermore, the method 700 may have an act (not shown) of fastening the actuation lever in the receiving section of the driver by way of a fastening device which is or can be arranged on the driver.

The described exemplary embodiments have been selected merely as examples, and may be combined with one another.

List of reference numerals

| | |
|---|---|
| 100 | Valve device |
| 110 | Valve |
| 120 | Valve body |
| 130 | Driver |
| 140 | Fastening device |
| 150 | Actuation lever |
| 200 | Valve device |
| 210 | Valve |
| 220 | Valve body |
| 230 | Driver |
| 240 | Fastening device |
| 250 | Actuation lever |
| 300 | Valve device |
| 310 | Valve |
| 320 | Valve body |
| 330 | Driver |
| 340 | Fastening device |
| 350 | Actuation lever with circular cross-sectional profile |
| 435 | Receiving section |
| 550 | Actuation lever with tetragonal cross-sectional profile |
| 700 | Method for assembling a valve device |
| 710 | Act of providing |
| 720 | Act of arranging |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A valve, comprising:
a valve body;
a driver of the valve body, the driver comprising a receiving section, wherein
the receiving section is configured to receive an actuation lever with a first cross-sectional profile or an actuation lever with a second cross-sectional profile, the first and second cross-sectional profiles differing from one another, without any retrofitting of the receiving section of the driver.

2. The valve according to claim 1, wherein the valve is a pneumatic suspension valve.

3. The valve according to claim 1, wherein the receiving section has a circular profile section for receiving the actuation lever having a circular cross-sectional profile and has a tetragonal profile section for receiving the actuation lever with a tetragonal cross-sectional profile.

4. The valve according to claim 3, wherein the circular profile section and the tetragonal profile section of the receiving section extend through the driver as a common passage opening along a receiving axis of the actuation lever in the receiving section.

5. The valve according to claim 4, wherein
the receiving section is configured to engage around narrow sides of a tetragonal cross-sectional profile of the actuation lever having a tetragonal cross-sectional profile in a U-shaped manner, and
wherein the receiving section is placed in contact with the narrow sides of the tetragonal cross-sectional profile and subsections of long sides of the tetragonal cross-sectional profile, which subsections adjoin the narrow sides.

6. The valve according to claim 4, wherein the receiving section is configured to be placed in contact with two circumferential subsections of a circular cross-sectional profile of the actuation lever having the circular cross-sectional profile.

7. The valve according to claim 3, wherein the receiving section is configured to be placed in contact with two circumferential subsections of a circular cross-sectional profile of the actuation lever having the circular cross-sectional profile.

8. The valve according to claim 1, further comprising a fastening device arrangeable on the driver, the fastening device serving to fasten the actuation lever in the receiving section of the driver.

9. The valve according to claim 8, wherein the fastening device has an axis of longitudinal extent that extends substantially transversely with respect to a receiving axis of the actuation lever in the receiving section.

10. A valve device, comprising:
a valve having a valve body with a driver, the driver having a receiving section; and
an actuation lever having a first cross-sectional profile or a second cross-sectional profile, the first and second cross-sectional profiles differing from one another, wherein
the receiving section of the driver is configured to receive the actuation lever with the first cross-sectional profile or the actuation lever with the second cross-sectional profile without any retrofitting of the receiving section.

11. The valve device according to claim 10, wherein the receiving section has a circular profile section for receiving the actuation lever having a circular cross-sectional profile and has a tetragonal profile section for receiving the actuation lever with a tetragonal cross-sectional profile.

12. The valve device according to claim 11, wherein the circular profile section and the tetragonal profile section of the receiving section extend through the driver as a common passage opening along a receiving axis of the actuation lever in the receiving section.

13. The valve device according to claim 12, wherein
the receiving section is configured to engage around narrow sides of a tetragonal cross-sectional profile of the actuation lever having a tetragonal cross-sectional profile in a U-shaped manner, and
wherein the receiving section is placed in contact with the narrow sides of the tetragonal cross-sectional profile and subsections of long sides of the tetragonal cross-sectional profile, which subsections adjoin the narrow sides.

14. The valve according to claim 11, wherein the receiving section is configured to be placed in contact with two circumferential subsections of a circular cross-sectional profile of the actuation lever having the circular cross-sectional profile.

15. The valve according to claim 10, further comprising a fastening device arrangeable on the driver, the fastening device serving to fasten the actuation lever in the receiving section of the driver.

16. The valve according to claim 15, wherein the fastening device has an axis of longitudinal extent that extends substantially transversely with respect to a receiving axis of the actuation lever in the receiving section.

17. A method for assembling a valve device, the method comprising the acts of:
providing a valve body having a driver;
providing an actuation lever attachable to the driver, the actuation lever having either a first cross-sectional profile or a second cross-sectional profile, which first and second cross-sectional profiles differ from one another; and
arranging the actuation lever in a receiving section of the driver, the receiving section being configured to alternatively receive the actuation lever with the first cross-sectional profile and the actuation lever with the second cross-sectional profile, without any need to retrofit the receiving section.

18. The method according to claim 17, further comprising the act of fastening the actuation lever in the receiving section of the driver via a fastener arranged on the driver.
